(19) United States
(12) Patent Application Publication
(10) Pub. No.: US 2004/0143697 A1
(43) Pub. Date: Jul. 22, 2004

(54) Communication module configurable with firmware and related method

(76) Inventors: Peter H. Mahowald, Los Althos, CA (US); Takashi Hidai, Palo Alto, CA (US); Frederick W. Miller, San Jose, CA (US); Mike Robinson, Fremont, CA (US)

Correspondence Address: AGILENT TECHNOLOGIES, INC., Legal Department, DL429, Intellectual Property Adminstration, P. O. Box 7599, Loveland, CO, 80537-0599, US

(21) Appl. No.: 10/346,999

(22) Filed: Jan. 16, 2003

(51) Int. Cl. G06F 12/00; G06F 12/14

(52) U.S. Cl. 711/103; 711/164

(57) ABSTRACT

A communication module operable to receive and transmit signals. The communication module includes a controller having a memory. The memory is operable to store a program, called a personality, having a plurality of performance characteristics for the receiving and transmitting of digital signals using the communication module.

### BACKGROUND OF THE INVENTION

Manufacturers of fiber-optic communication modules produce a wide variety of modules to serve the needs of customers who use the modules in a wide variety of applications. As a result, a manufacturer typically designs and manufactures a separate and distinct integrated circuit (or set of related integrated circuits (ICs)) for each application, the IC (or ICs) being connected together on a circuit board to form the module. For example, an application may require a module having a slow receiver rise/fall time for high data rates (1 gigabits per second (Gb/s) and a module having a fast receiver rise/fall time for low data rates (155 megabits per second (Gb/s). Therefore, an IC for a 155 Mb/s application is typically different than an IC for a 1 Gb/s application.

Separate types of ICs are typically expensive and time consuming to manufacture because each IC type typically requires a separate and dedicated manufacturing process and testing procedure. Each IC typically has a unique set of performance characteristics, often called a personality that is designed specifically for the application contemplated. As a result, the personality is typically programmed into a respective IC via a respective manufacturing process, and the personality is verified with a respective testing procedure. This is inefficient because often several types of ICs with only minor personality differences still require separate dedicated manufacturing processes and testing procedures.

An IC's personality typically includes a number of performance characteristics, e.g., the receiver bandwidth (where the IC includes a receiver) mentioned above. Some fiber-optic communication modules are designed to allow for changing one or two performance characteristics of the module's IC(s) after the IC(s) has/have been manufactured. One way to change a certain performance characteristic of a communication module is to design an IC with a pad that may be biased to a voltage source or to ground to determine the setting of the performance characteristic. For example, the voltage potential on the pad may determine whether the IC operates in a 1 Gb/s or a 2 Gb/s mode. More specifically, voltage (e.g., Vcc) on the pad may set the receiver bandwidth to below 1500 MHz (for a 1 Gb/s application) and no voltage (ground) on the pad may set the receiver bandwidth to above 1500 MHz (2 Gb/s application). Consequently, such an IC requires an additional pad for each selectable performance characteristic and the number of selectable performance characteristics is limited by the amount of space available on the IC for the pads. Implementing additional pads may also increase the cost and complexity of the IC's manufacturing process and testing procedure.

### SUMMARY OF THE INVENTION

One embodiment of the invention includes a communication module that includes a memory operable to store a software program and a controller coupled to the memory and operable to configure the module by executing the program. The communication module may further include an interface coupled to the controller and operable to allow an external device to set an operational characteristic of the module.

A communication module configurable via personality firmware allows fewer IC and module versions to be manufactured, and thus, may reduce the manufacturing cost and complexity. Furthermore, such a programmable communication module could be programmed with a first personality for a particular application and subsequently reprogrammed for a different application. An additional feature may include the ability to change the personality of the programmable communication module by biasing a control terminal to change a performance characteristic within the downloaded personality.

### BRIEF DESCRIPTION OF THE DRAWINGS

The foregoing aspects and many of the attendant advantages of this invention will become more readily appreciated as the same become better understood by reference of the following detailed description, when taken in conjunction with the accompanying drawings, wherein:

FIG. 1 is a block diagram of a communication module according to an embodiment of the invention; and

FIG. 2 is a block diagram of a communication system that incorporates at least one communication module of FIG. 1 according to an embodiment of the invention.

### DETAILED DESCRIPTION

The following discussion is presented to enable a person skilled in the art to make and use the invention. The general principals described herein may be applied to embodiments and applications other than those detailed below without departing from the spirit and scope of the present invention. The present invention is not intended to be limited to the embodiments shown, but is to be accorded the widest scope consistent with the principals and features disclosed or suggested herein.

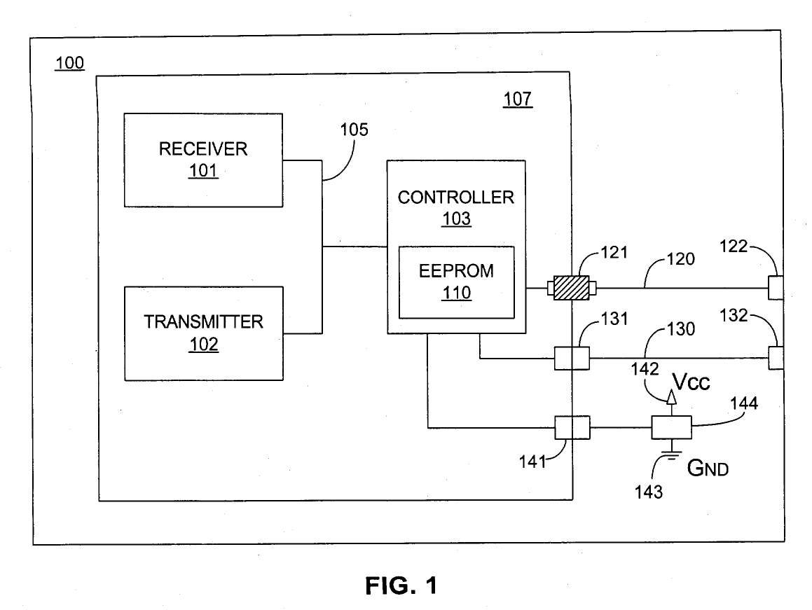

FIG.1 is a block diagram of a communication module 100 according to an embodiment of the invention. The communication module 100 includes one or more internal electronic components such as a receiver 101, a transmitter 102, and a controller 103, which may be coupled to an internal bus 105. Each electronic component may reside on different areas of a single IC, such as IC 107. Alternatively, each electronic component may be disposed on its own dedicated IC that each of which is mounted on a printed circuit board (not shown) that connects the ICs to one another. Likewise, the bus 105 may be disposed within a single IC 107 or may be a separate internal bus structure within the communication module 100. FIG. 1 shows a block diagram of the electronic components in a clear and separated arrangement that is intended solely for demonstrative purposes and ease of discussion.

In one embodiment, the communication module 100 incorporates eight independent data channels (four transmit and four receive channels which are not shown) for digital communication between fiber-optic communication devices. Such a module is disclosed in U.S. patent application Ser. No.______ entitled Integrated Multichanneled Laser Driver and Photodetector Receiver filed on ______ which is assigned to Aglient Technologies of Palo Alto, Calif. and which is incorporated by reference.

The controller 103 is the bus master for the bus 105 and facilitates communications between the controller 103 and other internal electronic components such as the receiver 101 and the transmitter 102. The controller 103 also includes an onboard memory, such as an EEPROM 110, (another embodiment uses flash memory) for storing a configuration program, i.e., firmware that dictates the performance characteristics, i.e., the personality, of the communication module 100. Alternatively, the firmware may be stored in a memory (not shown) that is separate from the controller 103.

The personality firmware is typically downloaded to the EEPROM 110 as one of the final steps in the manufacturing of the controller 103 prior to testing. Because the personality of the communication module 100 can be set with firmware, fewer versions of the module 100 and the IC(s) 107 that comprise the module 100 need to be manufactured. As such, manufacturing cost and complexity are often greatly reduced, as only one manufacturing line may be designed and implemented for a number of applications of the IC 107. Furthermore, one can easily change the personality of the module 100 by downloading different firmware to the EEPROM 110. For example, one can download the personality firmware to the EEPROM 110 via an external bus 120. In one embodiment, the external bus 120 is an industry standard two-wire serial bus 120 that couples bus pads 121 of the IC 107 (or whichever IC includes the controller 103) to a module interface 122. One uses the external bus 120 to download a personality to the EEPROM 110 from an external device (not shown) coupled to the module interface 122. Furthermore, the EEPROM 110 may store multiple personalities of the module 100, and the desired one of these personalities may be selected via the bus 120.

Once a personality is downloaded to the EEPROM 110, each time the communication module 100 is powered on, the firmware configures all ICs, such as IC 107, within the module 100 according to the personality, that is, the firmware will set the performance characteristics of the electronic components, such as the receiver 101 and the transmitter 102. The controller 103 may be designed such that only one having a proper password is able to access the EEPROM 110 and download personality firmware.

In another embodiment of the communication module 100, a bond wire 130 may be used to couple an external control terminal 132 to a control pad 131 so as to allow external control of the module 100 personality. An external controller (not shown) may generate one or more signals on the terminal 132 to set one or more desired performance characteristics of the module 100, regardless of the firmware stored in the EEPROM 110. For example, the external controller may select the bandwidth of one or more of the channels within the receiver 101. This selection may be made permanent by the external controller causing a change in the personality firmware or may be valid only while the external controller generates a proper signal. More specifically, the EEPROM 110 may be programmed with a personality that determines the setting of one or more particular performance characteristics based upon what voltage is at the external control pad 131. For example, a personality may look to the voltage on the external control pad 131 to determine whether the receiver rise/fall time should be fast or slow. In one embodiment, a low voltage or no voltage sets the receiver rise/fall time to fast and a high voltage sets the receiver rise/fall time to slow.

In this way, a particular performance characteristic, such as receiver bandwidth, may be externally set after the personality has been downloaded to the EEPROM 110. Furthermore, the particular performance characteristic may be changed in real time, as the external controller may change the voltage level at the external control terminal 132. There may be additional external control pads 131 coupled to additional external control terminals 132 that allow for additional performance characteristics to be externally set.

In yet another embodiment of the communication module 100, one or more performance characteristics may be set based upon the voltage level at an internal control pad 141. The internal control pad 141 is coupled to a signal source, i.e., a voltage source, such as Vcc 142, or ground 143. This internal control pad 141 is yet another pad located on the IC 107, and Vcc 142 and ground 143 nodes may be located within the communication module 100.

In a communication module 100 having one or more internal control pads 141, the EEPROM 110 may be programmed with a personality that determines the setting of a particular performance characteristic based upon a voltage at the internal control pads 141. As with the example described above, a personality may look to the voltage on the internal control pad 141 to determine whether the receiver rise/fall time should be fast or slow.

In this way, a particular performance characteristic may be internally set after the personality has been downloaded to the EEPROM 110. Furthermore, the performance characteristic may be changed, for example, as the connection to either Vcc 142 or ground 143 may be changed by a conventional switch 144 which may be accessible from outside of the module 100.

Still referring to FIG. 1, a number of different performance characteristics may be included in the personality of the module 100, and thus, may be controlled by the firmware that is downloaded to the EEPROM 110. In one embodiment, the personality firmware is a relatively small program that includes approximately 5,000 lines of code. Furthermore, as discussed above, the controller 103 may use the voltages at the internal 141 and external 131 pads to determine the setting of one or more performance characteristics. The following paragraphs summarize some of the performance characteristics that a particular personality may include.

One example of a performance characteristic is the receiver bandwidth of the transceiver. The receiver bandwidth is typically below 1500 MHz for 1 Gb/s applications and above 1500 MHz for 2 Gb/s applications. Depending upon the application, any value for receiver bandwidth may be programmed via the personality firmware stored in the EEPROM 110.

Another example of a performance characteristic is the way in which a communication module 100 handles the polarity of input, output, and internal signals. For example, for some communication modules 100, a valid input signal will typically set a signal detect (SD) flag. For other communication modules 100, a valid input signal will typically clear a loss of signal (LOS) flag. Furthermore, the particular input at which the flags (SD or LOS) occur is programmable so that the communication module 100 is operable to be used in different communication systems.

Yet another example of a performance characteristic, as described in examples above, includes the setting of the rise time and fall time for a laser driver in the communication module 100. For different data rates, the optimal value for the rise time (amount of time the laser driver takes to transition from the low threshold of an off signal to the high threshold of an on signal) and the fall time (amount of time the laser driver takes to transition from the high threshold of an on signal to the low threshold of an off signal) typically changes because of electromagnetic interference (EMI) present in the system. Thus, the rise time and the fall time are typically controlled by the personality firmware and are based on the level of expected EMI in the she system.

Still other examples of performance characteristics include, but are not limited to input and output functions, such as polarity of the transmit and receive signals, bias current for the input and output driver circuits, input and output impedance of the driver circuits, and transmit and receive signal shaping. Still other examples include internal circuit functions such as network topology, signal offset, signal gain, temperature coefficient, and sleep mode. Yet other examples include digital functions such as internal-component clock rate, type of external digital bus, and bit/byte function and polarity. Other performance characteristics may be included in the personality firmware but these characteristics are omitted for the sake of brevity.

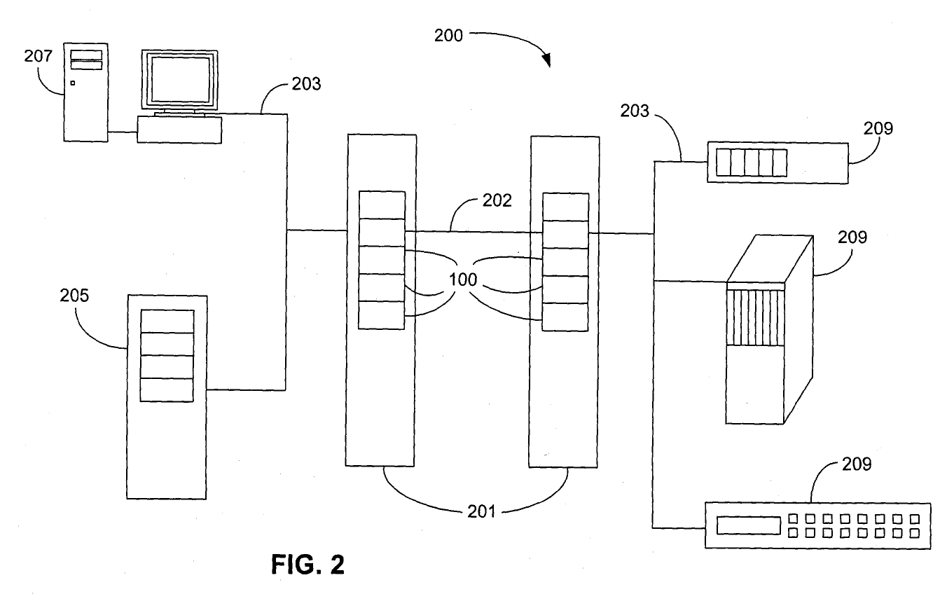

FIG. 2 is a block diagram of a communication system 200 that incorporates one or more communication modules 100 of FIG. 1 in accordance with an embodiment of the invention. The system 200 includes devices operable to communicate digitally with each other. Such devices include high-volume database computers 205, server computers 207, and network devices 209 (e.g., hubs, routers, switches). A conventional TX/RX link 203 couples the devices to a communication hub 201 that is operable to house several communication modules 100.

In one embodiment, a communication module 100 is typically one-half inch by one-half inch by two inches in size and includes one or more channels for receiving and transmitting data via a fiber-optic network. The communication module 100 can communicate with other communication modules 100 through conventional a fiber-optic communication link 202. As such, devices, such as high-volume database computers 205, server computers 207, and network devices 209 (e.g., hubs, routers, switches) can communicate with each other efficiently and effectively using the multichannel capabilities of the communication module 100.

We claim:

1. A communication module, comprising:
a memory operable to store a software program; and
a controller coupled to the memory and operable to configure the module by executing the program.

2. The communication module of claim 1, further comprising an interface coupled to the controller and operable to allow an external device to set an operational characteristic of the module.

3. The communication module of claim 1 wherein the memory is operable to receive the program from a source external to the module.

4. The communication module of claim 1 wherein the memory is password protected.

5. The communication module of claim 1 wherein the software program comprises firmware.

6. The communication module of claim 1 wherein the memory comprises an EEPROM.

7. The communication module of claim 1 wherein the memory comprises a flash memory.

8. The communication module of claim 1 wherein the memory is disposed within the controller.

9. A communication module, comprising:
a receiver operable to receive digital signals according to a performance characteristic;
a transmitter operable to transmit digital signals according to a performance characteristic;
a memory operable to store a software program; and
a controller coupled to the receiver, transmitter, and to the memory and operable to configure performance characteristics of the receiver and transmitter by executing the program.

10. The communication module of claim 9 wherein the receiver, transmitter, memory, and controller are disposed on a single integrated circuit.

11. The communication module of claim 9, further comprising a bus coupled to the memory and operable to allow loading of the program into the memory.

12. The communication module of claim 9, further comprising:
a control terminal coupled to the controller; and
wherein the controller is operable to set the performance characteristic of the receiver or transmitter in response to a signal on the control terminal.

13. An integrated circuit comprising:
a receiver operable to receive digital signals;
a transmitter operable to transmit digital signals;
a memory operable to store a software program; and
a controller coupled to the memory and operable to configure the receiving and transmitting by executing the program.

14. A communication system comprising:
a first module comprising:
a memory operable to store a software program; and
a controller coupled to the memory and operable to configure the module by executing the program;
a second comprising:
a memory operable to store a software program; and
a controller coupled to the memory and operable to configure the module by executing the program;
a communication link coupling the first module to the second module; and
a first communication device coupled to the first module and a second communication device coupled to the second module, the first communication device operable to transmit a digital signal to the second communication device via the communication link and the second communication device operable to transmit a digital signal to the first communication device via the communication link.

15. A method comprising:
executing a first software program to set a performance characteristic of a communication module; and
processing communication signals with the communication module according to the performance characteristic.

16. The method of claim 15, further comprising downloading the program to the communication module before executing the program.

17. The method of claim 15, further comprising altering the performance characteristic in response to receiving a signal at a control terminal of the communication module.

18. The method of claim 15, further comprising executing a second software program to change the performance characteristic.

19. The method of claim 15 wherein the processing comprises:
operating a receiver according to the performance characteristic; and
receiving the communication signals with the receiver.

20. The method of claim 15 wherein the processing comprises:
operating a transmitter according to the performance characteristic; and
transmitting the communication signals with the transmitter.

21. The method of claim 15, further comprising:
providing a password to the communication module;
determining whether the password is valid; and
downloading the software program to the communication module only if the password is valid.

22. A system comprising:
a module comprising:
a memory operable to store a software program; and
a controller coupled to the memory and operable to configure the module by executing the program; and
an external device coupled to the controller via a bus, the external device operable to download the program to the memory.

23. The system of claim 22 wherein the module comprises a fiber-optic communication module.
